(19) United States
(12) Patent Application Publication
(10) Pub. No.: US 2006/0253325 A1
(43) Pub. Date: Nov. 9, 2006

(54) Advertising method for use with a vehicle

(76) Inventor: Lars Schmidt, Burlington (CA)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/415,777

(22) Filed: May 2, 2006

(30) Foreign Application Priority Data
Apr. 22, 2005 (CA) 2,504,861

(51) Int. Cl. G07G 1/14

(52) U.S. Cl. 705/14

(57) ABSTRACT

A business method is disclosed. The method is for use with a vehicle having panels which are designed for ready removal and replacement by unskilled persons. The method comprises the steps of: contracting with another for the supply to the other of advertising services; arranging for an advertisement for the other to be provided on a panel of the type for use with said vehicle; and arranging for the panel to be operatively placed on said vehicle. Arrangements may be made for the vehicle to be deployed in a manner requested by the other. The entity practising the method may have possession rights to the vehicle. Alternatively, the method may be used with a vehicle owned by a contractor. The contract requires said vehicle owner to permit the vehicle to be used in the method and may require the owner to deploy the vehicle as requested by the other.

### FIELD OF THE INVENTION

The present invention relates to the field of advertising, and more particularly, to advertisements placed on automobiles.

### BACKGROUND OF THE INVENTION

In many developed economies, advertising is ubiquitous, and business constantly seeks new substrates upon which advertisements of goods and services can be placed for public viewing. One substrate which is commonly made the subject of print advertisement is the automobile; since automobiles are by definition mobile, automobile advertisements can come to the attention of many people. However, automobile advertisement has been somewhat limited to date. Certainly, many businesses adorn their fleet vehicles with company advertisements, and it is also known for advertisements to occasionally be placed on private vehicles, such as bumper stickers and vehicle wraps. However, most businesses have only a limited number of vehicles, and these are often needed to carry out the day-to-day operations of the business; this reduces the ability of the vehicles to be used for advertising purposes. As well, there is only a limited number of private citizens willing to deface their vehicles with prominent advertisements (absent an offer of substantial compensation).

### SUMMARY OF THE INVENTION

A business method is disclosed. The business method is for use with a vehicle of the type having panels which are designed so as to be readily removed and replaced by unskilled persons. The method comprises the steps of: contracting with another for the supply to the other of advertising services; arranging for an advertisement for the other to be provided on a panel of the type for use with said vehicle; and arranging for the panel to be operatively placed on said vehicle.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which being briefly described hereinbelow.

### BRIEF DESCRIPTION OF THE DRAWINGS

FIG. 1 is a front, left side perspective view of a vehicle with which a preferred embodiment of the invention is used.

FIG. 2 is a front, right side perspective view of the vehicle of FIG. 1, wherein a front panel is shown in the process of removal.

### DETAILED DESCRIPTION

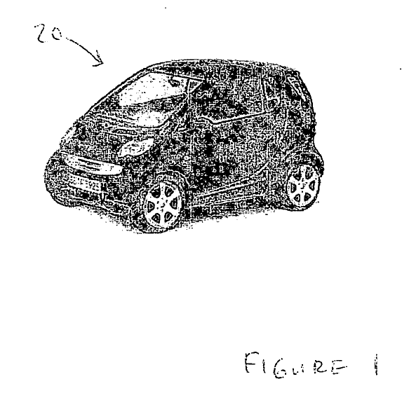

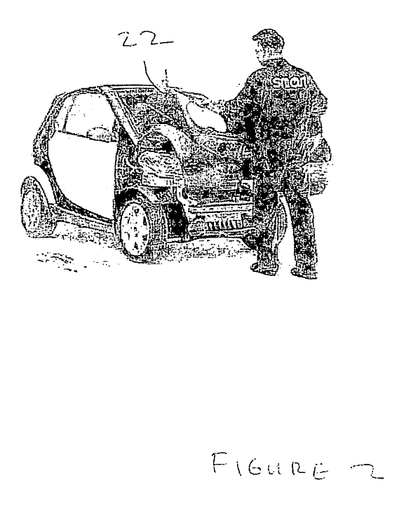

The method of the present invention takes advantage of vehicles, such as the car sold by DaimlerChrysler AG under the trade-mark SMART, which include panels which are easily removed and replaced. A vehicle 20 of this type is shown in FIG. 1. These vehicles 20 are intended by the manufacturer to permit owners to, inter alia, easily change panels as desired, for example, if a panel becomes damaged, or if an owner wishes to change the colour or overall appearance of a vehicle, for reasons of aesthetics or fashion. FIG. 2 shows a panel 22 being removed from a vehicle. The manner of construction of such vehicles, and the manner in which the panels thereof are removed and replaced, are both well known to persons of ordinary skill in the art and as such are not detailed herein.

In the method, an advertisement is placed on a panel, and the panel is placed on a vehicle, so as to deliver the advertisement to any locale to which the vehicle travels.

In one possible business model, an advertising firm has possession of a plurality of vehicles of the requisite functionality and an inventory of panels. The panels are emblazoned with signage by the advertising firm, to meet the desires of its clientele, and the cars are deployed by paid personnel as requested by the advertiser. This could mean driving the vehicles along routes in which they are likely to be seen by the target market sought by the advertiser, for example, along a major thoroughfare of a city, or parking the vehicles in locations where they are likely to be seen by the target market sought by the advertiser, for example, in front of stadiums, shopping malls or cinemas. The panels allow the vehicles to be easily configured to switch between advertisers. Thus, the same vehicle can be used in different advertising programs with minimal cost associated with the switch.

In another possible business model, the advertising firm has relations with a plurality of persons who each own a vehicle of the requisite functionality. From time to time, as assignments are received, the advertising firm and the vehicle owners make arrangements for panels reflecting the new assignment to be fitted to the vehicles (the panels could be owned by the advertising firm, or the advertiser). This could be done by shipping the panels to the vehicle owners, who could make arrangements for the panel reconfiguration, or do the replacement themselves. Alternatively, the advertiser could attend at the home or office of the vehicle owner with panels, and make the substitution. Yet further, the vehicle owner could attend at premises designated by the advertiser, whereupon the panels could be replaced. If desired by the advertiser, the advertising firm and the vehicle owners may also make arrangements for the vehicles to be deployed in a certain manner by the vehicle owners.

The vehicles could be deployed en masse, so as to dominate a location of interest. For example, the parking area at a PGA event might be viewed as a location of interest to a golf ball manufacturer. Such a manufacturer might well wish to purchase an inventory of panels, suitably branded with signage of the manufacturer, and arrange for the advertiser to have a large number of vehicles fitted with the panels driven to the PGA event by persons attending the event. At the end of the event, the signage could be retrieved by the manufacturer and brought to a subsequent event, in another location, for future reuse. Alternatively, the vehicles could be deployed individually, as a subtle message. For example, a salesperson might wish for a car to be parked occasionally in the parking lot of a particular company that had been identified as a possible purchaser. In this event, a vehicle of the advertising firm could be fitted with panels on any day in which the car was to be parked on the lot. On days in which the car was to be used for other campaigns, the panels could easily be removed and stored by the advertising firm, until the next scheduled use.

Persons of ordinary skill in the art will readily appreciate that other business models, methods and deployments are possible. Accordingly, the invention is to be understood as limited only by the claims appended hereto, purposively construed.

1. A business method for use with a vehicle of the type having panels which are designed so as to be readily removed and replaced by unskilled persons, the method comprising the steps of:
contracting with another for the supply to the other of advertising services;
arranging for an advertisement for the other to be provided on a panel of the type for use with said vehicle; and
arranging for the panel to be operatively placed on said vehicle.

2. A method according to claim 1, further comprising the step of arranging for the vehicle to be deployed in a manner as requested by the other.

3. A method according to claim 1, further comprising the step of obtaining rights to possess a vehicle, wherein the vehicle with which the method is used is the vehicle to which rights to possession have been obtained.

4. A method according to claim 1, further comprising the step of entering into a contract with a vehicle owner, said contract requiring said vehicle owner to permit the method to be used with the vehicle owned by said owner, wherein the vehicle with which the method is used is the vehicle owned by said owner.

5. A method according to claim 4, wherein the contract requires said vehicle owner to deploy the vehicle in a manner as requested by the other.

6. A method according to claim 2, further comprising the step of obtaining rights to possess a vehicle, wherein the vehicle with which the method is used is the vehicle to which rights to possession have been obtained.
